(19) United States
(12) Patent Application Publication
(10) Pub. No.: US 2025/0018230 A1
(43) Pub. Date: Jan. 16, 2025

(54) RESCUE DEVICE

(71) Applicant: SpanSet Inter AG, Wollerau (CH)

(72) Inventor: Peter John Ward, Flintshire Clwyd (GB)

(21) Appl. No.: 18/710,126

(22) PCT Filed: Nov. 22, 2022
(86) PCT No.: PCT/EP22/82840

§ 371 Date: May 14, 2024

(30) Foreign Application Priority Data
Nov. 23, 2021 (GB) 2116827.3

(51) Int. Cl. A62B 1/10

(52) U.S. Cl. CPC A62B 1/10

(57) ABSTRACT

There is provided a rescue device for rescuing a person suspended from a structure, the rescue device comprising a friction device configured to be coupled to a rope, the friction device comprising an adjustment mechanism for adjusting the amount of friction acting on the rope, and a pulley unit configured to be used with the rope to form a pulley, the pulley unit comprising at least one pulley wheel and a one-way freewheel clutch coupled to the at least one pulley wheel, wherein the one-way freewheel clutch is configured to allow the at least one wheel to rotate in a first rotational direction and prevent the wheel from rotating in a second rotational direction.

### TECHNICAL FIELD

The present invention relates to a rescue device for rescuing a person suspended from a structure by fall arrest equipment.

### BACKGROUND

UK Patent GB2376009B, which is incorporated herein by reference, describes a prior art fall arrest rescue system for rescuing a person, e.g. a casualty, suspended from a structure. For example, the casualty may be suspended by their lanyard, having fallen off the structure. FIGS. 1 to 3 illustrate a fall arrest rescue device of GB2376009B. FIG. 1 a and b show a pulley 2 having a proximal end 4 and a distal end 6. The pulley is of normal type comprising a single pulley 5 and a double pulley 7 having first and second pulley wheels 10, 8 with a rope 12 extending from its point of attachment on the single pulley 5, passing around the first pulley wheel 10 of the double pulley 7, back around the single pulley 5 and then out around the second pulley wheel 8 of the double pulley 7.

The pulley 2 is attached at its proximal end to a safety clip 14, which is in turn attached to an anchor sling 16 which is held around an anchor point 50, which in the situation shown is a girder 50. The pulley 2 therefore hangs suspended from the girder 50 under gravity. In FIG. 1a the anchor point 50 is at foot level of the rescuer and in FIG. 1b the anchor point 50 is above foot level of the rescuer.

FIG. 2 shows a connector 18 attached at its proximal end 20 to a telescopic pole 22 (only partly shown). The connector 18 has a pair of jaws 24, 26 which can be moved from a closed configuration in which the jaws touch or overlap to an open configuration in which there is a gap between the jaws, by a safety clip 28. The jaws 24, 26 are spring loaded so that once an item has passed through the jaws they snap into the closed configuration, holding the item in the aperture 30 defined between the closed jaws.

The connector 18 in FIG. 2 is shown attached to an adapter 32. The adapter 32 comprises an axial bore (not shown) extending laterally part way therethrough. The bore is dimensioned so as to provide an interference fit with the telescopic pole 22.

The adapter 32 further comprises a loop of webbing 34, which webbing loop 34 may be attached to the distal end 6 of the pulley 2.

FIG. 3 shows how the rescue device of the prior art is used to attach the pulley 2 to the harness 36 of a casualty 38 suspended by a lanyard 40.

An example of the how the rescue device may be used to rescue a casualty suspended by a lanyard is now described with reference to FIGS. 1 to 3.

In order to carry out a rescue a rescuer requires a harness with a front point of attachment for a friction device. If the anchor point for the rescue device is such that the casualty must be lowered, then the rope in the rescue device should ideally be a minimum of four times the distance from the anchorage to the point of safety.

When a casualty 38 is suspended from an anchorage point by a lanyard 40, the rescuer must access the anchorage point with the rescue device. The rescuer then attaches the anchor sling 16 to a suitable anchor point. The suitable anchor point is normally the one that the casualty is already suspended from. Of course, if there is a more suitable anchor point, such as above the rescuer, then the rescuer can use that as higher anchor points provide the option to raise the casualty to safety or lower them to safety whereas low anchor points typically only allow the rescuer to lower the casualty. For an anchor point that is 1-1.5 metres above foot level of the rescuer the double pulley 7 end of the pulley 2 is clipped to the anchor sling 16 and anchor sling 16 is attached to the anchor point. For an anchor sling 16 that is at foot level of the rescuer the single pulley 5 end of the pulley is clipped to the anchor sling 16 and the anchor sling 16 is attached to the anchor point 50.

The extendible pole 22 is then extended to the required length to reach the casualty. The connector 18 is then attached to one end of the pole 22 via the adapter 32, providing an interference fit with the pole 22. The pulley 2 is attached at its free end (which may be the single pulley 5 or the double pulley 7, depending on where the anchor point is relative to the rescuer) via safety clip 36 to the loop of webbing 34 on the adapter 32. In FIG. 2, for example, the double pulley 7 is attached to the adapter 32.

The ropes between the single pulley 5 and the double pulley 7 are then adjusted to about the same length as the pole 22 and the connector jaws 24, 26 set to open. The pole is then used to attach the connector, and thus the pulley, to an anchor point on the casualty, in this case a metal ring 42 on the casualty's harness 36.

The pole 22 is then removed from the connector 18. The rescuer then attaches a friction device (not shown) such as a GRI GRI™ to their harness and pulls the slack rope through the device to tension the system.

The mode of operation then varies, depending on where the rescuer is with regard to the anchor point 50. When the anchor point 50 is above the rescuer, once the system is tensioned the rescuer sits down to raise the casualty. Then with one hand the rescuer holds the rope above the friction device close to the attachment sling 16. With the other hand they take in slack rope as they stand up.

When the anchor point 50 is at the foot level of the rescuer, as the system is tensioned the rescuer squats down. The rescuer then stands up, thus raising the casualty. Then with one hand the rescuer holds the rope below the friction device close to the attachment sling 16. With the other hand they take in slack rope as they squat down. In both scenarios once the casualty's weight has been transferred to the pulley 2 the lanyard 40 can be disconnected. The casualty can then be raised to a point of safety or lowered.

### SUMMARY

It is an object of the present disclosure to provide an improved rescue device.

In a first aspect there is provided a rescue device for rescuing a person suspended from a structure, the rescue device comprising a friction device configured to be coupled to a rope, the friction device comprising an adjustment mechanism for adjusting the amount of friction acting on the rope, and a pulley unit configured to be used with the rope to form a pulley, the pulley unit comprising at least one pulley wheel and a one-way freewheel clutch coupled to the at least one pulley wheel, wherein the one-way freewheel clutch is configured to allow the at least one wheel to rotate in a first rotational direction and prevent the wheel from rotating in a second rotational direction.

The person suspended from the structure may be referred to as a casualty. The rescue device may be configured for rescuing a person suspended from a structure, the person wearing fall arrest equipment, such as a fall arrest lanyard.

Advantageously, the rescue device comprising a friction device and a pulley unit with a one-way freewheel clutch provides two separate friction components in the rescue system. The one-way freewheel clutch provides a first friction component and the friction device provides a second, variable, friction component. The second friction component is variable, in that the amount of friction provided may be manually adjusted by a rescuer. Providing two separate components of friction, where one component is adjustable, helps improve a rescuer's control when operating the rescue device.

This is particularly useful in cases where any of relatively thin rope, light wheels, and more efficient wheel bearings coupled to pulley wheels are used. In such cases, a lighter and more compact rescue device can be provided. Such a rescue device is better for the rescuer as it is easier to transport to the workplace, particularly when carrying up multiple levels of a structure. It will then be more available for use if required avoiding delay in the event of an accident.

The one-way freewheel clutch may be coupled to the at least one pulley wheel, such that, in use, the one-way freewheel clutch is configured to allow the at least one wheel to rotate in the first rotational direction when lifting the person suspended from the structure and prevent the wheel from rotating in the second rotational direction when lowering the person suspended from the structure.

The friction device may be an assisted braking device, such as a Beal Birdie™ or Petzl Gri Gri™.

The adjustment mechanism may comprise a handle or lever which can be manipulated by the rescuer to adjust the amount of friction acting on the rope. For example, the lever may change an angle of a cam surface within the friction device about which the rope extends. The friction device may be configured to automatically lock if the rope is loaded. The adjustment mechanism may be used to release the lock. For example, in use, holding a casualty stationary may utilise the friction device in a locked position, as the rope leaving the friction device is loaded with the casualty's weight. As the rescuer starts applying a force (e.g. starts pulling the rope either by squatting down or standing up), the casualty is raised while the friction device is locked onto the rope. The rescuer then holds the casualty stationary with one hand while taking in slack rope through the friction device with the other hand. For example, if the rescuer squatted down to raise the casualty, the rescuer will hold the casualty stationary while standing up, feeding slack rope through the friction device as they stand up. As slack rope is being fed through the friction device, the friction device is unloaded and so does not provide friction at this stage (e.g. the second component of friction is not utilised when feeding slack rope through the friction device). However, the first friction component is utilised at this stage by providing friction which acts against the casualty being lowered. That is, the first friction component assists the rescuer in holding the causality stationary while the rescuer is feeding slack rope through the friction device. Lowering the casualty may utilise both the first and second friction components simultaneously, where the friction device provides variable friction when using the adjustment mechanism.

The friction device may be located external to the pulley. That is, the friction device May not be located (or configured to act) at, or between, any one of the pulley wheels. The friction device may be configured to be coupled to the rescuer. For example, the friction device may be configured to be coupled to a rescuer's harness.

The one way freewheel clutch may be coupled to any suitable pulley wheel. The one way free wheel clutch may be coupled to the wheel closest to the friction device, e.g. may be coupled to the entry point (e.g. entry wheel) of the pulley.

The pulley unit may comprise a first pulley unit comprising a first pulley wheel and a second pulley unit comprising a second pulley wheel, wherein the at least one pulley wheel comprises one or both of the first and second pulley wheels.

The second pulley unit may comprise a third pulley wheel, wherein the at least one pulley wheel comprises one or more of the first, second or third pulley wheels.

That is, the one way freewheel clutch may be coupled to any one of the first, second or third pulley wheel. There may be multiple one-way freewheel clutches such that each may be coupled to two or more of the first, second or third pulley wheels. Alternatively, there may only be one one-way free wheel clutch coupled to just one pulley wheel.

The first pulley unit may be referred to as a single pulley unit, as it may have only a single wheel, and the second pulley unit may be referred to as a double pulley unit as it may have only two wheels.

The at least one pulley wheel may comprise the first wheel. That is, the one-way freewheel clutch may be coupled to the wheel in the first pulley unit.

In another configuration the at least one pulley wheel may comprise the third wheel, and wherein the third wheel is configured as the entry wheel to the pulley. That is, the one way freewheel clutch may be coupled to the wheel closest (in terms of the rope path) to the friction device.

The rescue device may be configured to couple to the rope in any suitable configuration.

The friction device and first and second pulley units may be configured to receive rope that extends from a point of attachment on the first pulley unit to the second pulley wheel of the second pulley unit, passing around the second pulley wheel, extending from the second pulley wheel to the first pulley wheel of the first pulley unit, passing around the first pulley wheel, extending from the first pulley wheel to the third pulley wheel of the second pulley unit, passing around the third pulley wheel, and extending from the third pulley wheel to the friction device.

The point of attachment may be an aperture in the first pulley unit. The aperture may be configured such that the rope can be threaded through the aperture and folded back and attached, e.g. stitched or glued, to another portion of the rope.

The rescue device may be configured such that, in use, the rope does not extend more than 360 degrees about the at least one pulley wheel.

In other words, the rope does not need to be wrapped multiple times about the same wheel in order to increase friction between the rope and the wheel. Put another way, the rope may contact only a portion of the wheel, said portion covering less than the circumference of the wheel. For example, the portion may be a portion extending less than or equal to about 50% of the circumference of the wheel. As such, the rope would then not extend more than 360 degrees about the wheel. Of course, depending on the number of pulley units and pulley wheels used, the rope may extend about the pulley units more than once, via different wheels.

The rescue device may be configured to be used with rope having a diameter less than or equal to 10 mm.

For example, the rope may have a diameter equal to 8.5 mm, or equal to 10 mm, or any value between 8.5 mm and 10 mm. The rope may have a diameter equal to about 9 mm. The rope may have diameter of 9.5 mm, 9.6 mm or around 9.5 mm to 9.6 mm. The two friction components provided by the friction device and one way free wheel clutch allow the rescue device to use a relatively thin rope, while maintaining safety of the kit. Using thinner rope provides for a more compact and lighter rescue device.

The at least one wheel may comprise a wheel having diameter equal to or less than 38 mm.

In an example embodiment, the wheel may have a diameter of 23 mm, or about 23 mm. All wheels used in the rescue device may have the same size diameter. The two friction components provided by the friction device and one way free wheel clutch allow the rescue device to use a relatively small wheels, while maintaining safety of the kit. Using smaller wheels provide for a more compact and lighter rescue device.

The first pulley unit may comprise an integrally formed first connector, the first connector for connecting to one of the suspended person or an anchor point.

Integrally forming the first connector with the first pulley unit can help reduce both the weight and dimensions of the rescue device. The connector may be connected to a coupling on a harness of the suspended person. The anchor point may be any suitable anchor point, such as a part of the structure.

The second pulley unit may comprise an integrally formed second connector, the second connector for connecting to one of the suspended person or an anchor point.

The one way freewheel clutch may comprise a sprag clutch.

The friction device may comprise a third connector, the third connector configured for connecting the friction device to an operator of the rescue device.

The operator of the rescue device may be referred to as the rescuer.

The friction device may comprise a locking mechanism, the locking mechanism configured to prevent removal of the friction device from the rope, the locking mechanism comprising the third connector.

The friction device may comprise a plate, the plate moveable between an open position and a closed position, wherein the open position allows the friction device to be couple to the rope and the closed position prevents the friction device from being decoupled from the rope, and the third connector may comprise a carabiner coupled to the friction device such that the plate cannot move between the open and closed positions.

The plate may be moveable relative to a body of the friction device. The third connector may be coupled to the friction device by passing the third connector though an aperture in the plate and an aperture in the body of the friction device, such that relative movement between the plate and body is prevented. The aperture in the plate and the aperture in the body of the friction device may be aligned when the plate is in a closed position.

The third connector may comprise a separating element separating a first region of the third connector and a second region of the third connector, the first region comprising a gate of the third connector and the second region comprising a portion of the friction device. That is, when third connector is coupled to the friction device, a portion of the friction device will be located in the second region of the third connector. Due to the separating element, the friction device cannot be moved to the first region of the third connector, where the first region comprises the gate of the third connector.

In this way, the third connector prevents the plate from being opened (and hence the rope from being decoupled from the friction device) and the separating element prevents the friction device from being removed from the third connector via the gate. That is, the The separating element may be a captivating pin. The captivating pin may extend from one side of the carabiner to the other side of the carabiner. The captivating pin may not be removalable during normal use. This has the advantage that the kit cannot be reconfigured incorrectly, improving safety and making it easier for the rescuer to carry out a set procedure and focus on the casualty in their time of need.

The rescue device may further comprise the rope, the rope coupled to the friction device and pulley unit.

The rope may have a diameter equal to 8.5 mm, or equal to 10 mm, or any value between 8.5 mm and 10 mm. The rope may have a diameter equal to about 9 mm. The rope may have diameter of 9.5 mm, 9.6 mm or around 9.5 mm to 9.6 mm.

The rescue device may be pre-assembled. That is, the rescue device may be provided to a rescuer in a pre-assembled form with the rope coupled to the friction device, first pulley unit and second pulley unit.

In a second aspect, there is provided a method of operating the rescue device according to the first aspect, the method comprising lowering a person suspended from a structure, wherein lowering the person may comprise introducing rope through the friction device and into the pulley so as to lower the person, wherein lowering the person causes a first friction component to be generated between the rope and the at least one wheel and causes a second friction component to be generated between the rope and the friction device, said first and second friction components providing resistance to the lowering of the person.

The method may further comprise raising the person suspended from the structure, wherein raising the person may comprise applying a force to the rope so as to raise the person, taking in slack rope through the friction device while holding the person stationary so as to remove the slack rope from the pulley, wherein holding the person stationary is assisted by the first friction component generated between the rope and the at least one wheel.

That is, the two friction components combine to assist the operator (e.g. rescuer) when lowering a person, and the first friction component assists the operator when holding the person stationary and slack rope is removed from the pulley. When the operator is taking in slack rope, the second friction component may not assist (because, for example it is unloaded).

Applying the force to the rope so as to raise the person may comprise a rescuer standing up, or squatting down.

Taking in the slack rope may be done once the rescuer has finished standing up, or squatting down. Taking in slack rope may be done as the rescuer returns to either a squatting position or standing position (a squatting position if the rescuer stood up to raise the person, and a standing position if the rescuer squatted down to raise the person).

Once the slack rope has been removed from the pulley, the rescuer may repeat the process so as to continue to lift the person.

### BRIEF DESCRIPTION OF FIGURES

The invention will now be further described by way of example only with reference to the accompanying drawings, in which:

FIG. 1 shows a pulley of a rescue device attached to an anchor point, in FIG. 1a the anchor point is at foot level of the rescuer; in FIG. 1b the anchor is above the level of the rescuer;

FIG. 2 shows a connector of the rescue device attached to a pole according to the prior art and to the pulley;

FIG. 3 shows the attachment of the connector to the harness of a person suspended from an elevated position wearing a general-purpose safety harness attached to a lanyard;

FIG. 4 shows a first pulley unit;

FIG. 5 shows a second pulley unit;

FIG. 6 shows a friction device in a closed configuration;

FIG. 7 shows a friction device in an open configuration to receive rope; and

FIG. 8 shows an assembled rescue device comprising the first pulley unit, second pulley unit and friction device.

### DETAILED DESCRIPTION

It is advantageous that such rescue devices described above be as light and as compact as possible. This is because such rescue devices often need to be carried up to an elevated position, such as up multiple levels of a structure (e.g. building). Additionally, space may be severely limited when trying to access higher levels of buildings, particularly buildings that are undergoing construction. For example, access to the higher levels of buildings may only be possible via one or more hatches or hooped ladders.

It has been realised by the present inventor that using a thinner rope and/or smaller, lighter, pulleys and/or pulley wheels in rescue devices can significantly reduce the weight and size of the rescue device. However, the present inventor has found that using thinner rope and/or smaller, lighter, pulleys/pulley wheels leads to a reduction in control when using the rescue device. There are multiple reasons for such reductions in control. The components of the rescue device weigh less, and so there is less inertia in the system when in use. The diameter of the rope is reduced and so there is less friction between the rope and wheels of the pulley due to the reduced contact area between the rope and the wheels. These issues combine such that, in use, there is less resistance to acceleration of a casualty due to gravity than when using thicker rope and larger, heavier, pulley wheels. This reduction in resistance leads to a reduction in control, for example when holding or lowering a casualty. A reduction in control leads to an increased risk to human safety, even in the case of a trained and competent person acting as the rescuer. However, such a reduction in control is particularly problematic when the rescue device is used by non-experts, e.g. other workers in the vicinity of the casualty, which is typically the case for such rescue devices described herein.

Additionally, it has been found by the inventor that when using bearings for coupling pulley wheels to their axels, more efficient bearings improve function when raising a casualty as there is less resistance to movement provided by the efficient bearings. However, more efficient bearings also lead to a reduction in control when holding a casualty stationary or when lowering a casualty. This is due to a reduction in the resistance against acceleration within the pulley.

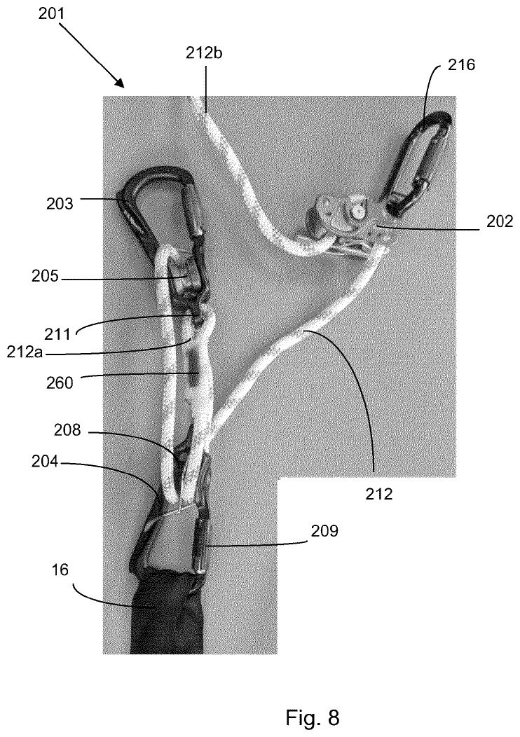

In order to address such issues, an improved rescue device 201 is provided (see FIG. 8 for a complete view of the rescue device 201). The rescue device 201 comprises a friction device 202 (which may be an assisted breaking device), a first pulley unit 203, a second pulley unit 204 and a rope 212. The first pulley unit 203, second pulley unit 204, and rope 212 form a pulley system (also referred to simply as a pulley).

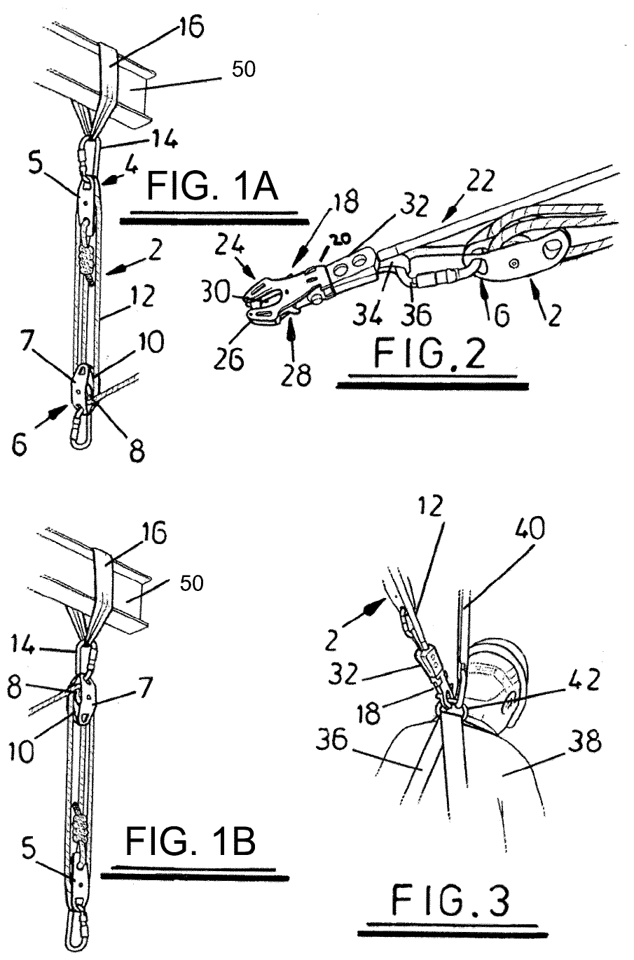

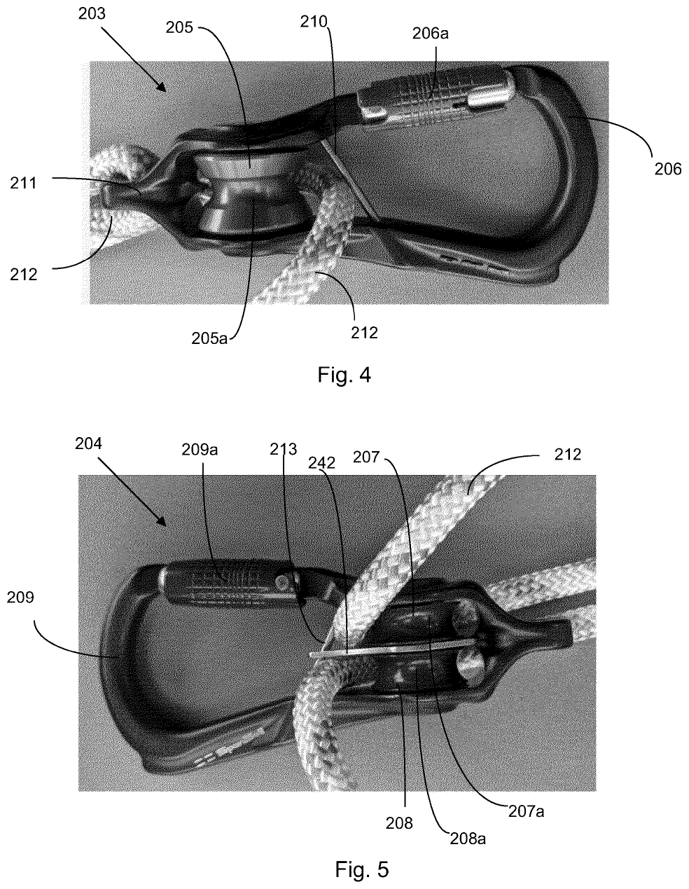

The first pulley unit 203 is a single pulley, which can perform the function of single pulley 5 of FIGS. 1a and 1b. FIG. 4 shows a view of the first pulley unit 203. The first pulley unit 203 comprises a first pulley wheel 205 and first connector 206. The first pulley wheel 205 is configured to freely rotate in only one direction, while being prevented from rotating in the other direction, as will be described in further detail below. For example, the first pulley wheel 205 may be prevented from rotating in one rotational direction by a one way freewheel clutch. In FIG. 4, rope 212 has been partially lifted from the first pulley wheel 205 in order to more clearly show the first pulley wheel 205. The first connector 206 comprises an integral carabiner, which includes a gate 206a. Gate 206a is a carabiner gate that can be opened/closed to allow the carabiner to couple to another object, such as the anchor sling 16 or anchor point 42. That is, the carabiner is integrally formed with the pulley unit 203. Integrally forming the carabiner with the pulley unit 203 reduces the size (specifically the length) and weight of the first pulley unit 203 over that of the single pulley 5 shown in FIG. 1. In order to provide a barrier so as to separate the first pulley wheel 205 and rope 212 from the first connector 206, a captivating pin 210 can optionally be provided between the first pulley wheel 205 and first connector 206. The captivating pin 210 is physically held in place relative to the first pulley unit 203. The captivating pin 210 helps prevent the first pulley wheel 205 and rope 212 from physically contacting a connector (such as an anchor sling or anchor point) which has been connected to the first connector 206 via gate 206a, and also prevents the rope 212 from coming out of the pulley unit 203 (e.g. coming off the first pulley wheel 205). The captivating pin 210 may be secured in place, such that a user cannot remove the captivating pin 210, e.g. by being driven through two corresponding holes in the first connector 206, and held in place via an interference fit between the holes and the pin 210. Alternatively, the pin 210 may be held securely in place using any other means, such as welding, gluing, screwing etc.

The first pulley unit 203 comprises an attachment point 211 for attaching the rope 212 to the first pulley unit 203. In the example shown, the attachment point 211 is an integrally formed aperture configured to allow the rope 212 to be threaded through. Once threaded through the aperture, the rope 212 is tied or stitched so as to attach a first end 212a of rope 212 to the first pulley unit 203 (see FIG. 8). While an aperture has been shown, any suitable means may be used to fix the rope 212 to the pulley unit 203, such as a clamp for clamping the rope.

The second pulley unit 204 is a double pulley, which can perform the function of the double pulley 7 of FIGS. 1a and 1b. FIG. 5 shows a view of the second pulley unit 204. The second pulley unit 204 comprises a second pulley wheel 207, third pulley wheel 208 and second connector 209. The second wheel 207 and third wheel 208 are configured to freely rotate in both rotational directions. For example, the second pulley wheel 207 and third pulley wheel 208 may be coupled to an axel in the pulley unit 204 (not shown) via one or more bearings, said bearings allowing rotation of the second and third pulley wheels 207, 208 in both rotational directions. In FIG. 5, rope 212 has been partially lifted from the second and third pulley wheels 207, 208 in order to more clearly show the second and third pulley wheels 207, 208. The second connector 209 comprises an integral carabiner 209 which includes a gate 209a. Gate 209a is a carabiner gate which can be opened/closed to allow the carabiner to couple to another object, such as the anchor sling 16 or anchor point 42. That is, as with the first connector 206 of the first pulley unit 203, the second connector 209 is integrally formed with the second pulley unit 204. A captivating pin 213 is optionally provided between the second and third pulley wheels 207, 208 and the second connector 209, in a similar manner to captivating pin 210 provided in the first pulley unit 203. The captivating pin 213 may be secured in place, such that a user cannot remove the captivating pin 213, e.g. by being driven through two corresponding holes in the second connector 209, and held in place via an interference fit between the holes and the pin 213. Alternatively, the pin 213 may be held securely in place using any other means, such as welding, gluing, screwing etc. The second and third pulley wheels 207, 208 may be physically separated from each other by a plate 242. The plate 242 can help prevent a portion of rope 212 extending about one pulley wheel 207 from interfering with the rope 212 extending about the other pulley wheel 208.

Integrally forming the carabiner with the pulley units 203, 204 provides a reduction in weight of each pulley unit 203, 204 when compared with traditional pulley units where a carabiner is clipped onto the pulley unit, as shown in FIGS. 1a and 1b. Furthermore, providing an integrally formed carabiner reduces the length of the pulley units 203, 204 over the pulleys shown in FIGS. 1a and 1b. Additionally, as shown, the second and third pulley wheels 207, 208 may share the same rotational axis, further reducing the length of the second pulley unit 204. Reducing the length of the pulley unit increases the height with which a casualty can be raised, making it easier to recover the casualty. For example, the inventor has found that a casualty may be raised an additional 150 mm higher when using pulley units 203, 204 that have integral carabiners than when using prior art pulleys 5, 7 as described with reference to FIGS. 1a and 1b.

As described above, the first pulley unit 203 comprises a one way freewheel clutch. The one way freewheel clutch allows the first pulley wheel 205 to rotate freely in one rotational direction, but prevents the first pulley wheel 205 from rotating in the opposite rotational direction. In an embodiment, the one way freewheel clutch is a sprag clutch. The one way freewheel clutch may be coupled to the first pulley wheel 205 using any suitable means. For example, an axel (not shown) on which the first pulley wheel 205 spins may be fixed relative to the first pulley unit 203, and a sprag clutch may be coupled between the axel and the first pulley wheel 205. As will be described later, the purpose of the one way freewheel clutch is to allow the first pulley wheel 205 to rotate in a first rotational direction when lifting a casualty, and prevent the first pulley wheel 205 from rotating in a second rotational direction when lowering the casualty. Additionally, by preventing rotation in the second rotational direction, it is easier for the rescuer to hold the casualty stationary, such as when attempting to take in slack rope by moving the friction device 202 along the rope to “bank” the effort expended when lifting a casualty, which is described in more detail later. By preventing rotation of the first pulley wheel 205 when lowering the casualty, the rope 212 is caused to slide over the surface of the first pulley wheel 205, increasing the friction within the pulley system. This, when combined with the friction device 202, helps improve overall control over the casualty.

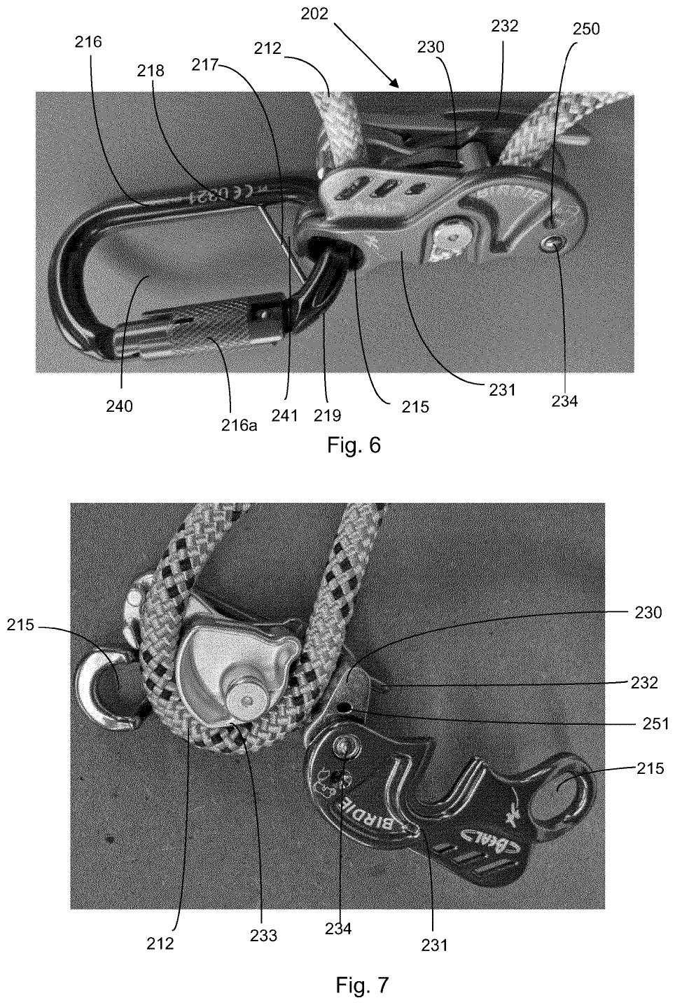

FIG. 6 shows a view of the friction device 202 coupled to a carabiner 216. The friction device 202 may be an assisted braking device. An example of a suitable assisted braking device is the Beal Birdie™ or Petzl GriGri™. The friction device 202 shown in FIG. 6 is a Beal Birdie™ and comprises a body 230, a plate 231 and a lowering handle 232. The plate 231 is rotationally fixed to the body 230, and can be rotated relative to the body 230 about pivot point 234 so as to expose an opening into the body 230 through which the rope 212 can be inserted and routed about cam 233 within the body 230. FIG. 7 shows the friction device 202 in a configuration where the plate 231 is open (e.g. in an open position) and FIG. 6 shows the friction device 202 in a configuration where the plate 231 is closed (e.g. in a closed position). When the friction device 202 has been coupled to the rope 212 (e.g. when the rope has been inserted into the body 230 and routed about the cam 233), the plate 231 is rotated about pivot point 234 so as to cover the opening, retaining the rope 212 within the body 230 of the friction device 202. As will be known, the arrangement of the rope 212 and cam 233 provide the friction device 202 with an automatic locking function when rope leaving the friction device 202 (e.g. towards the casualty) is suddenly tensioned.

Both the body 230 and the plate 231 comprise apertures which align to form aperture 215 when the plate 231 is in the closed position shown in FIG. 6. Carabiner 216 is installed through both apertures (e.g. through aperture 215) which assists in preventing the plate 231 from opening, exposing the rope 212. A further safety feature is provided in the form of a separating element 217 separating a first region 240 of the carabiner 216 and a second region 241 of the carabiner 216. The first region 240 comprising a gate 216a of the carabiner 216 and the second region comprising a portion of the friction device 202. In the example shown, the separating element 217 is provided by a captivating pin. The captivating pin 217 may be driven through two corresponding holes 218, 219 in the carabiner, and held in place via an interference fit between the holes 218, 219 and the pin 217. Alternatively, the pin 217 may be held securely in place using any other means, such as welding, gluing, screwing etc. The separating element 217 physically separates gate 216a of carabiner 216 and the friction device 202 (e.g. provides a physical barrier between the gate 216a and the friction device 202). In this way, the friction device 202 cannot be removed, either by accident or on purpose, from the carabiner 216 as the pin 217 prevents this. Given that the friction device 202 cannot be removed from the carabiner 216, the plate 231 cannot be rotated relative to the body 230 (due to the carabiner 216 being installed through both apertures 215 in the plate 231 and the body 230.) and so cannot be opened to expose the rope 212. The addition of the separating element 217 therefore improves safety. This is particularly useful in the case of rescue devices of the present disclosure as typically the rescuer is not an expert. In additional, a further safety feature can be provided in the form of an attachment element (such as a screw (not shown)) being inserted and secured in aperture 250 in the plate 231, said attachment element extending into aperture 251 in the body 230. That is, apertures 250 and 251 may align when the friction device 202 is in the closed position, allowing the attachment element to extend into both apertures 250, 251. Apertures 250, 251 are offset from the pivot point 234 such that the attachment element, when inserted through both apertures 250, 251, would prevent the plate 231 from being rotated relative to the body 230. Of course, in other examples, an alternative to a screw may be used.

The carabiner 216 is configured to be coupled to the rescuer. That is, the carabiner 216 may be connected to a harness on the rescuer via gate 216a. Coupling the carabiner 216 to the rescuer helps keep the friction device 202 within reach of the rescuer, allowing the rescuer to operate the friction device 202. Additionally, the rescuer's harness then forms the anchor point for the friction device 202, allowing it to resist any force being applied to the rope (from, for example, the casualty) and thus its automatic locking function can be activated.

The one way freewheel clutch provides a first friction component and the friction device 202 provides a second friction component. The first friction component is located within one of the pulley units (the first pulley unit 203 in the present example). The second friction component is located external to the pulley units, and is coupled to the rescuer. The first friction component is not adjustable by the rescuer. The second friction component is adjustable by the rescuer. For example, the rescuer can manipulate the lowering handle 232 of the friction device 202 to increase or decrease friction between the friction device 202 and the rope 212. The two friction components are used together to improve control when lowering, and hence safety, of the rescue device. Additionally, the increase in friction within the pulley system helps enable a single rescuer to rescue a casualty of a greater weight than would otherwise be possible. For example, when raising the casualty it is easier to hold the rope while taking excess rope in through the friction device 202, as the friction in the pulley system is increased due to the presence of the one way freewheel clutch.

FIG. 8 shows a view of the rescue device 201 showing the friction device 202, first pulley unit 203, and second pulley unit 204 connected together by the rope 212. The second connector 209 is shown as being connected to sling 16, where the sling 16 is configured to be coupled to an anchor point as shown in FIG. 1b.

The rope 212 may comprise rope having diameter equal to or less than 10 mm. The rope 212 may have a diameter of about 8.5 mm-10 mm. For example, the rope diameter may be equal to or greater than 8.5 mm and may be equal to or less than 10 mm. In a particular example, the rope diameter may be about 9.5-9.6 mm. The rope 212 has first end 212a and a second end 212b (as shown in FIG. 8). The first end 212a is configured to be fixed to the attachment point 211 of the first pulley unit 203. FIG. 8 shows the first end of the rope 212a, being fixed to the first pulley unit 203 by threading a portion of the rope 212 through the attachment point 211 of the first pulley unit 203, and folding the portion of rope 212 back such that the portion of rope can be stitched using stitching 260 to a portion of rope that has not been threaded through the aperture 211.

As can be seen in FIG. 8, the rope 212 extends from the attachment point 211 on the first pulley unit 203 to the second pulley wheel 207 (obscured by the rope 212 in FIG. 8) of the second pulley unit 204, passing around the second pulley wheel 207 and extending from the second pulley wheel 207 to the first pulley wheel 205 of the first pulley unit 203. The rope 212 then passes around the first pulley wheel 205, and extends from the first pulley wheel 205 to the third pulley wheel 208 of the second pulley unit 204. The rope 212 passes around the third pulley wheel 208 and then extends from the third pulley wheel 208 to the friction device 202.

The second end 212b of the rope 212 corresponds with a portion of rope that emerges from the friction device 202 on a side opposite to the side comprising the pulley units 203, 204. The second end 212b can be considered to be the free end of the rope.

The pulley wheels 205, 207, 208 of the pulley units 203, 204, are configured to receive the rope. For example, and with reference to FIGS. 4 and 5, the pulley wheels each have a track or groove 205a, 207a, 208a in which the rope may be accommodated. The rope 212 is arranged around the first, second a third pulley wheels such that, in use, the rope contacts only a portion of each pulley wheel. That is, in use, the rope sits within a respective track 205a, 207a, 208a, contacting less than 360 degrees of a surface of each track 205a, 207a, 208a as the rope extends about each pulley wheel. That is, in use, the rope does not extend more than 360 degrees about the pulley wheels 205, 207, 208. In other words, due to the presence of the one way free wheel clutch and the friction device 202, the rope does not need to be wrapped multiple times about the same pulley wheel (such as, for example, when using a drum) in order to increase friction between the rope and the pulley wheel. As such, the pulley wheels can be made smaller.

Each track 205a, 207a, 208a may be shaped so as to maximise a contact region between the rope and the track. For example, the track may be generally semi-circular in cross section when used with rope having a circular cross section. Maximising a contact region between the rope 212 and the pulley wheels in this way can help further increase the friction in the pulley system. The tracks 205a, 207a, 208a, are smooth in the example shown. However, if additional friction in the pulley system is required, the track of the pulley wheel which is coupled to the one way freewheel clutch, which in the example described is the first pulley wheel 205, may comprise a relatively rough surface. For example, the surface of track 205a may be knurled so as to comprise a knurling pattern.

There is now described a method of using the improved rescue device 201. Consider the case where the casualty 38 is suspended from an anchor point 50 by a lanyard 40 (which may be a fall arrest lanyard), as shown in FIG. 3. As described in the background section above, the relative orientation of the pulleys 5, 6 (e.g. and hence the pulley units 203, 204), depends on where the anchor point 50 is located relative to the rescuer. For the following example, it will be assumed that the anchor point 50 is located at around the foot level of the rescuer. This is often known as a low anchor rescue.

The pulley units 203, 204 are coupled between an anchor point and the casualty suspended from a structure. For example, the rescuer attaches the anchor sling 16 to a suitable anchor point above the casualty, such as the anchor point 50. The first (single) pulley unit 203 is clipped to the anchor sling 16 (as shown in FIG. 1a) using the first connector 206, and the second (double) pulley unit 204 is clipped to an anchor point on the casualty. An example of such an anchor point is the metal clip 42 of the casualty's harness 36 shown in FIG. 3. The double pulley unit 204 may be clipped to the anchor point on the casualty using any suitable means. For example, connector 18 may be used, as shown in FIGS. 2 and 3, where the double pulley unit 204 may be manipulated using the pole 22 as described above. For example, the double pulley unit 204 may be attached via the second connector 209 to the loop of webbing 34 on the adapter 32. Of course, in other examples, the connector 18 and pole 22 are not required. For example, if the casualty is within reach of the rescuer, the rescuer may manually attach the double pulley unit 204 to the anchor point on the casualty. In another example, if the casualty is conscious, the casualty may attach the double pulley unit 204 to their harness.

The friction device 202 is coupled to the rescuers harness. For example, the rescuer attaches carabiner 216 to their harness. Once the friction device 202 is coupled to the rescuer's harness, and the single pulley unit 203 is coupled to the anchor point 50 and the double pulley unit 204 is coupled to the casualty, the rescuer can first raise a casualty to release their lanyard and then either raise or lower a casualty.

The rescuer can, for example, squat down and pull the rope 212 through the friction device 202 to tension the rope 212 on the pulley side of the friction device 202. The rescuer then applies force to the rope by standing up, thus raising the casualty. As the rescuer pulls the rope upwards when moving from a squatted position to a standing position, friction between the rope 212 and the first, second and third pulley wheels 205, 207, 208 of the pulley units 203, 204 cause the first, second and third pulley wheels 205, 207, 208 to rotate freely about their axes, providing negligible resistance.

When the rescuer has stood up, the rescuer can then take in slack rope through the friction device 202 while holding the person stationary so as to remove rope from the pulley system. For example, with one hand the rescuer holds the rope 212 below the friction device 202 as close to the pulley 204 as possible (e.g. holds a portion of rope 212 between the friction device 202 and second pulley unit 204). With the other hand they pull on the second end of the rope 212b and take in slack rope through the friction device 202 as they squat down.

This process can be repeated until the casualty is raised to a sufficient height such that their lanyard 40 can be disconnected safely. Holding the casualty stationary while taking in slack during lifting is assisted by the first friction component generated between the rope and the first pulley wheel 205. For example, the one way free wheel clutch assists in this operation by assisting the rescuer when holding the rope, helping prevent the rope re-entering the pulley system while taking in the slack during raising of the casualty. This is particularly helpful in cases where a thin rope is used, such as rope having diameter less than 10 mm.

Once the casualty's lanyard is disconnected, their weight is supported by the rescuer via the pulley units 203, 204, friction device 202 and rope 212. With the casualty's lanyard disconnected, the rescuer may lower the casualty, e.g. down to ground level.

In order to lower the casualty, the rescuer introduces rope 212 through the friction device 202 and into the pulley system. Lowering the casualty causes the first friction component to be generated between the rope and the first pulley wheel 205 (said first pulley wheel 205 coupled to the one way freewheel clutch) and the second friction component to be generated between the rope and the friction device 202. The first and second friction components provide resistance to the lowering of the person. For example, to lower the casualty, the rescuer takes hold of the rope 212 that exits the friction device 202 (e.g. takes hold of the second end 212b of the rope 212). With the other hand the rescuer then uses the lowering handle 232 on the friction device 202 to adjust the amount of friction acting between the rope 212 and the friction device 202 while feeding the rope 212 through the friction device 202 (e.g. the second friction component is adjusted using the lowering handle 232). The slack provided by the additional rope into the pulley system is immediately taken up by the weight of the casualty, maintaining tension in the rope 212 while lowering the casualty.

As the rescuer lets out the rope, friction between the rope 212 and the second and third pulley wheels 207, 208 of the second pulley unit 204 cause the second and third pulley wheels 207, 208 to rotate freely about their axes. However, the first pulley wheel 205 in the single pulley unit 203 comprises the one way freewheel clutch which is configured to prevent rotation of the first pulley wheel 205 when lowering a casualty. As such, the rope 212 slides over the surface of the first pulley wheel 205 while lowering the casualty. Said sliding causes an increase in the friction within the pulley system, e.g. provides the first friction component described above. The combination of the first and second friction components improve control when lowering the casualty. This is particular useful in cases where a relatively thin rope is used, such as when the rope is less than 10 mm in diameter.

In the alternative, when the anchor point 50 is above the rescuer, the second pulley unit 204 is clipped to the sling 16, which is then attached to the anchor point 50. Once the system is tensioned the rescuer sits down to raise the casualty. Then with one hand the rescuer holds the rope 212 above the friction device 202 close to the attachment sling 16 (e.g. holds a portion of rope 212 between the friction device 202 and second pulley unit 204). With the other hand they pull rope 212b and take in slack rope through the friction device 202 as they stand up. As the rescuer raises the casualty all of the pulley wheels 205, 207, 208 rotate freely about their axes, providing negligible resistance. Should the casualty need to be lowered, the rescuer performs the steps described above. That is, the rescuer takes hold of the rope that exits the friction device 202 (e.g. takes hold of the second end 212b of the rope 212). With the other hand the rescuer then uses the lowering handle 232 on the friction device 202 to adjust the amount of friction acting between the rope 212 and the friction device 202 while feeding the rope 212 through the friction device 202 (e.g. the second friction component is adjusted using the lowering handle 232). Adjusting the amount of friction acting between the rope 212 and the friction device 202 helps to regulate the speed at which the casualty is lowered.

While the first pulley unit is shown with one pulley wheel, and the second pulley unit is shown with two pulley wheels, it will be appreciated that pulley units having another number of pulley wheels may be used, depending on the mechanical advantage required. However, it is has been found that the described arrangement of having a first pulley unit with one pulley wheel and a second pulley unit with two pulley wheels provides a good balance between total weight of the pulley system and mechanical advantage provided.

It is advantageous to place the one way free wheel clutch in the single pulley unit 203 (e.g. coupled to the first pulley wheel 5) as, in use, the rope 212 generally extends about 180 degrees about the circumferential surface of the pulley wheel 205, no matter the relative positioning of the rescuer and casualty. While the one way freewheel clutch has been described as coupled to the first pulley wheel 205, (e.g. the pulley wheel 205 on the single pulley unit 203) it will be appreciated that the one way freewheel clutch may be coupled instead to the second pulley wheel 207 in the second pulley unit, or to the third pulley wheel 208 in the second pulley unit 204.

In an alternative embodiment, the one way freewheel clutch is coupled to the third pulley wheel 208. That is, the one way freewheel clutch is coupled to the pulley wheel closest (in terms of the rope path) to the friction device 202 (as can be seen in FIG. 8). The pulley wheel closest to the friction device 202 can be thought of as the entry point of the pulley system, as rope enters the pulley system via said pulley wheel. For example, as can be seen in FIG. 8, the rope enters the pulley system via the third pulley wheel 208.

Alternatively, or additionally, there may be multiple one way freewheel clutches used. For example, there could be two one way freewheel clutches. For example, one free wheel clutch could be coupled to the first pulley wheel 205 and the other coupled to the second pulley wheel 207. Using multiple one way free wheel clutches can increase the friction within the system, but can also increase the complexity of the device 201.

The rescue device may be provided within a bag, allowing the device to be easily transported to where it is required, e.g. the top of a building. Reducing the size of the rescue device as described above therefore allows a smaller bag to be used, making it easier to, for example, fit through hatches. The rescue device may be pre-assembled. That is, the rescue device may be provided to a rescuer in a pre-assembled form with the rope 212 coupled to the friction device 202, first pulley unit 203 and second pulley unit 204.

As described above, by providing the two friction components, the dimensions and weight of the rescue device can be reduced. As an example, an embodiment of the rescue device 201 having a 9 mm rope of 50 m in length weighs 5.58 kg. This is contrast to the device described in GB2376009 GB, which weighs 7.72 kg.

Therefore, a lighter, smaller, rescue device is provided which does not comprise on user safety.

While various embodiments have been described herein, it will be appreciated that this description is in all respects illustrative, not restrictive. Various modifications will be apparent to the skilled person without departing from the spirit and scope of the invention.

1. A rescue device for rescuing a person suspended from a structure, the rescue device comprising:
a friction device configured to be coupled to a rope, the friction device comprising an adjustment mechanism for adjusting the amount of friction acting on the rope;
a pulley unit configured to be used with the rope to form a pulley, the pulley unit comprising:
at least one pulley wheel;
a one-way freewheel clutch coupled to the at least one pulley wheel, wherein the one-way freewheel clutch is configured to allow the at least one wheel to rotate in a first rotational direction and prevent the wheel from rotating in a second rotational direction.

2. The rescue device of claim 1, wherein the pulley unit comprises:
a first pulley unit comprising a first pulley wheel;
a second pulley unit comprising a second pulley wheel, wherein the at least one pulley wheel comprises one or more of the first, or second pulley wheels.

3. The rescue device of claim 2, wherein the second pulley unit comprises a third pulley wheel, wherein the at least one pulley wheel comprises one or more of the first, second or third pulley wheels.

4. The rescue device of claim 3, wherein the at least one pulley wheel comprises the first wheel.

5. The rescue device of claim 4, wherein the friction device and first and second pulley units are configured to receive rope that extends from a point of attachment on the first pulley unit to the second pulley wheel of the second pulley unit, passing around the second pulley wheel, extending from the second pulley wheel to the first pulley wheel of the first pulley unit, passing around the first pulley wheel, extending from the first pulley wheel to the third pulley wheel of the second pulley unit, passing around the third pulley wheel, and extending from the third pulley wheel to the friction device.

6. The rescue device of claim 5, wherein the rescue device is configured such that, in use, the rope does not extend more than 360 degrees about the at least one pulley wheel.

7. The rescue device of claim 6, where the rescue device is configured to be used with rope having a diameter less than or equal to 10 mm.

8. The rescue device of claim 7, wherein the at least one wheel comprises a wheel having diameter equal to or less than 38 mm.

9. The rescue device of claim 6, wherein the first pulley unit comprises an integrally formed first connector, the first connector for connecting to one of the suspended person or an anchor point.

10. The rescue device of claim 9, wherein the second pulley unit comprises an integrally formed second connector, the second connector for connecting to one of the suspended person or an anchor point.

11. The rescue device of claim 10, wherein the one way freewheel clutch comprises a sprag clutch.

12. The rescue device of claim 1, wherein the friction device comprises a third connector, the third connector configured for connecting the friction device to an operator of the rescue device.

13. The rescue device of claim 12, wherein the friction device comprises a locking mechanism, the locking mechanism configured to prevent removal of the friction device from the rope, the locking mechanism comprising the third connector.

14. The rescue device of claim 13, wherein the friction device comprises a plate, the plate moveable between an open position and a closed position, wherein the open position allows the friction device to be couple to the rope and the closed position prevents the friction device from being decoupled from the rope; and
the third connector comprises a carabiner coupled to the friction device such that the plate cannot move between the open and closed positions.

15. The rescue device of claim 14, wherein the third connector comprises a separating element separating a first region of the third connector and a second region of the third connector, the first region comprising a gate of the third connector and the second region comprising a portion of the friction device.

16. A method of operating the rescue device of claim 15, the method comprising:
lowering a person suspended from a structure, wherein lowering the person comprises:
introducing rope through the friction device and into the pulley so as to lower the person,
wherein lowering the person causes a first friction component to be generated between the rope and the at least one wheel and causes a second friction component to be generated between the rope and the friction device, said first and second friction components providing resistance to the lowering of the person.

17. The method of claim 16, further comprising:
raising the person suspended from the structure, wherein raising the person comprises:
applying a force to the rope so as to raise the person;
taking in slack rope through the friction device while holding the person stationary so as to remove the slack rope from the pulley;
wherein holding the person stationary is assisted by the first friction component generated between the rope and the at least one wheel.

18. A method of operating the rescue device of claim 1, the method comprising:
lowering a person suspended from a structure, wherein lowering the person comprises:
introducing rope through the friction device and into the pulley so as to lower the person,
wherein lowering the person causes a first friction component to be generated between the rope and the at least one wheel and causes a second friction component to be generated between the rope and the friction device, said first and second friction components providing resistance to the lowering of the person.

19. The method of claim 18, further comprising:
raising the person suspended from the structure, wherein raising the person comprises:
applying a force to the rope so as to raise the person;
taking in slack rope through the friction device while holding the person stationary so as to remove the slack rope from the pulley;
wherein holding the person stationary is assisted by the first friction component generated between the rope and the at least one wheel.

20. The rescue device of claim 2, wherein the at least one pulley wheel comprises the first wheel, and wherein the friction device and first and second pulley units are configured to receive rope that extends from a point of attachment on the first pulley unit to the second pulley wheel of the second pulley unit, passing around the second pulley wheel, extending from the second pulley wheel to the first pulley wheel of the first pulley unit, passing around the first pulley wheel, extending from the first pulley wheel to the third pulley wheel of the second pulley unit, passing around the third pulley wheel, and extending from the third pulley wheel to the friction device.
